(19) United States
(12) Patent Application Publication
(10) Pub. No.: US 2017/0177298 A1
(43) Pub. Date: Jun. 22, 2017

(54) INTERACTING WITH A PROCESSING STSYEM USING INTERACTIVE MENU AND NON-VERBAL SOUND INPUTS

(71) Applicant: INTERNATIONAL BUSINESS MACHINES CORPORATION, ARMONK, NY (US)

(72) Inventors: Christopher J. Hardee, Raleigh, NC (US); Steve Joroff, Tokyo (JP); Pamela A. Nesbitt, Raleigh, NC (US); Scott E. Schneider, Rolesville, NC (US)

(21) Appl. No.: 14/978,014

(22) Filed: Dec. 22, 2015

(51) Int. Cl. G06F 3/16; G06F 3/0482

(52) U.S. Cl. CPC G06F 3/167; G06F 3/0482

(57) ABSTRACT

Examples of techniques for interacting with a processing system using an interactive menu and a non-verbal sound input are disclosed. In one example implementation according to aspects of the present disclosure, a computer-implemented method may include receiving a command to initiate the interactive menu. The method may further include presenting the interactive menu to a user of the processing system, the interactive menu comprising a plurality of interactive menu options. The method may further include performing an action on the processing system based on receiving a non-verbal sound input from the user responsive to at least one of the plurality of interactive menu options presented to the user.

### BACKGROUND

The present disclosure relates to interacting with a processing system and, more particularly, to interacting with a processing system using an interactive menu and non-verbal sound inputs.

Users of processing systems (e.g., smart phone computing devices, laptop computing devices, tablet computing devices, desktop computing devices, wearable computing devices, etc.) may frequently interact with their processing systems. For example, a user may use a mouse, button, touch screen, keyboard, microphone, or other suitable input device to interact with the user's processing system. The processing system may present information to the user via a display, printer, speaker, or other suitable output device. However, these interactions may be disruptive to persons nearby the user, such as in a meeting. Additionally, disabled persons may not be able to interact with these processing systems in traditional ways.

### SUMMARY

In accordance with aspects of the present disclosure, a computer-implemented method for interacting with a processing system using an interactive menu and a non-verbal sound input is provided. The method may include receiving a command to initiate the interactive menu. The method may further include presenting the interactive menu to a user of the processing system, the interactive menu comprising a plurality of interactive menu options. The method may further include performing an action on the processing system based on receiving a non-verbal sound input from the user responsive to at least one of the plurality of interactive menu options presented to the user.

In accordance with additional aspects of the present disclosure, a system for interacting with a processing system using an interactive menu and a non-verbal sound input is provided. The system may include a processor in communication with one or more types of memory. The processor may be configured to receive a command to initiate the interactive menu. The processor may be further configured to present the interactive menu to a user of the processing system, the interactive menu comprising a plurality of interactive menu options. The processor may also be configured to perform an action on the processing system based on receiving a non-verbal sound input from the user responsive to at least one of the plurality of interactive menu options presented to the user.

In accordance with yet additional aspects of the present disclosure, a computer program product for interacting with a processing system using an interactive menu and a non-verbal sound input is provided. The computer program product may include a non-transitory storage medium readable by a processing circuit and storing instructions for execution by the processing circuit for performing a method. The method may include receiving a command to initiate the interactive menu. The method may further include presenting the interactive menu to a user of the processing system, the interactive menu comprising a plurality of interactive menu options. The method may further include performing an action on the processing system based on receiving a non-verbal sound input from the user responsive to at least one of the plurality of interactive menu options presented to the user.

### BRIEF DESCRIPTION OF THE DRAWINGS

The subject matter which is regarded as the invention is particularly pointed out and distinctly claimed in the claims at the conclusion of the specification. The forgoing and other features, and advantages thereof, are apparent from the following detailed description taken in conjunction with the accompanying drawings in which:

FIG. 1 illustrates a block diagram of a processing system for implementing the techniques described herein according to examples of the present disclosure;

FIG. 2 illustrates a block diagram of a processing system which may be interacted with by a user using an interactive menu and non-verbal sound inputs according to examples of the present disclosure;

FIG. 3 illustrates a flow diagram of interacting with a processing system using an interactive menu and non-verbal sound inputs according to examples of the present disclosure; and

FIGS. 4A and 4B illustrate a flow diagram of a method for navigating an interactive menu according to examples of the present disclosure.

### DETAILED DESCRIPTION

Various implementations are described below by referring to several examples of interacting with a processing system using an interactive menu and non-verbal sound inputs. There may be situations where it is difficult, inappropriate, or impossible for a user of the processing system to use voice commands to control or interact with the processing system. For example, if the user cannot look at the screen of the processing system or does not have access to the device because it is in a coat pocket but can receive audio output from the processing system, the user can still communicate basic commands to the device using non-verbal sounds.

In some implementations, the present techniques enable a user to interact with a processing system without having direct access to the processing system (e.g., the processing system is in a coat pocket, the user is in a meeting in which it is not appropriate to have the processing device visible to other meeting attendees, etc.). In examples, the user may interact with the processing system without the use of a clicking device (e.g., buttons on a mouse) or other special hardware device. The interactive menu may be user customizable to facilitate ease of use. These and other advantages will be apparent from the description that follows.

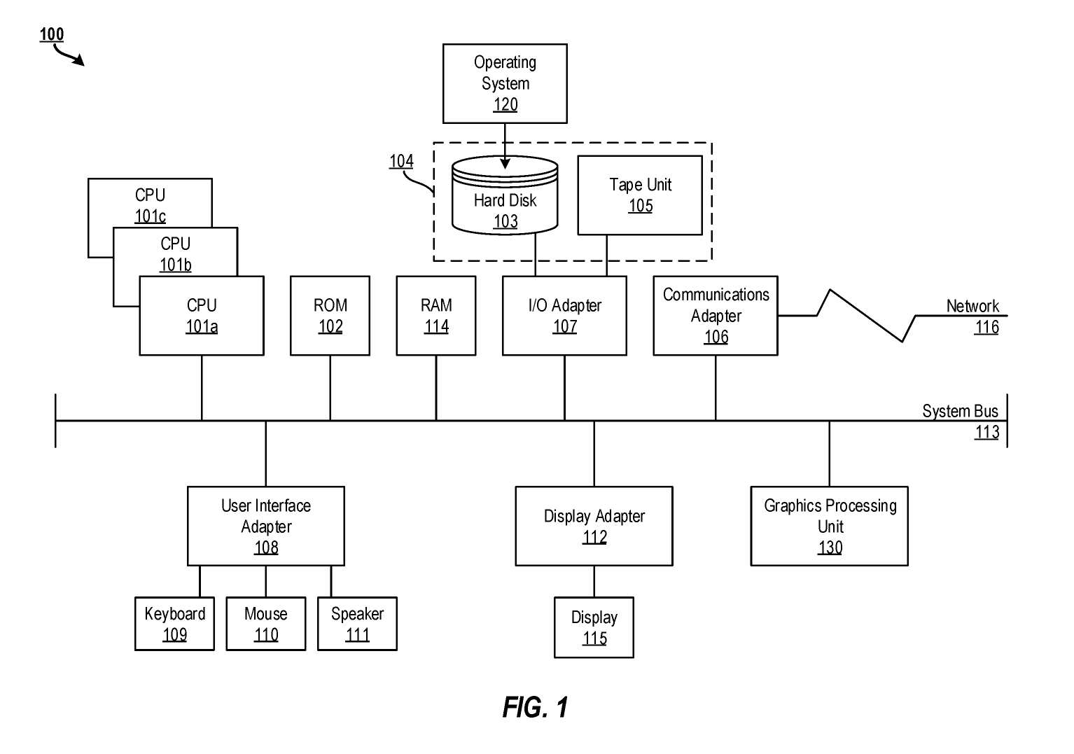

FIG. 1 illustrates a block diagram of a processing system 100 for implementing the techniques described herein. In examples, the processing system 100 has one or more central processing units (processors) 101a, 101b, 101c, etc. (collectively or generically referred to as processor(s) 101). In aspects of the present disclosure, each processor 101 may include a reduced instruction set computer (RISC) microprocessor. Processors 101 are coupled to system memory (e.g., random access memory (RAM) 114 and various other components via a system bus 113. Read only memory (ROM) 102 is coupled to the system bus 113 and may include a basic input/output system (BIOS), which controls certain basic functions of the processing system 100.

FIG. 1 further illustrates an input/output (I/O) adapter 107 and a communications adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling the processing system 100 to communicate with other such systems.

A screen (e.g., a display monitor) 115 is connected to system bus 113 by display adaptor 112, which may include a graphics adapter to improve the performance of graphics intensive applications and a video controller. In one aspect of the present disclosure, adapters 106, 107, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In some aspects of the present disclosure, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing, and has a highly parallel structure that makes it more effective than general-purpose CPUs for algorithms where processing of large blocks of data is done in parallel.

Thus, as configured in FIG. 1, the processing system 100 includes processing capability in the form of processors 101, storage capability including system memory 114 and mass storage 104, input means such as keyboard 109 and mouse 110, and output capability including speaker 111 and display 115. In some aspects of the present disclosure, a portion of system memory 114 and mass storage 104 collectively store an operating system such as the AIX® operating system from IBM Corporation to coordinate the functions of the various components shown in FIG. 1.

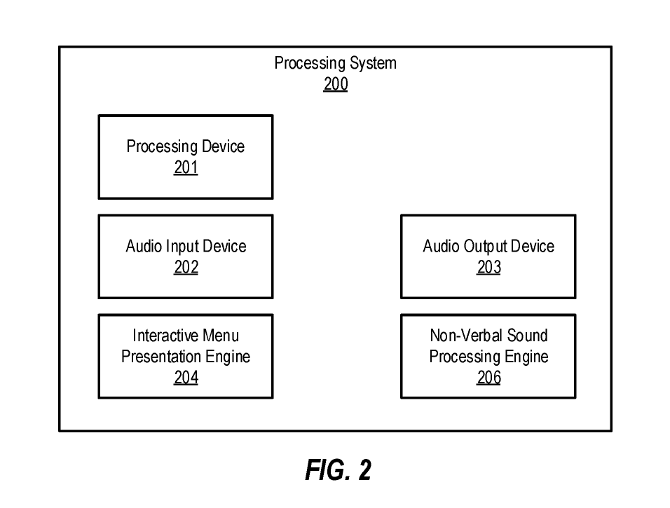

FIG. 2 illustrates a block diagram of a processing system 200 which may be interacted with by a user using an interactive menu and non-verbal sound inputs according to examples of the present disclosure. The various components, modules, engines, etc. described regarding FIG. 2 may be implemented as instructions stored on a computer-readable storage medium, as hardware modules, as special-purpose hardware (e.g., application specific hardware, application specific integrated circuits (ASICs), as embedded controllers, hardwired circuitry, etc.), or as some combination or combinations of these. In examples, the engine(s) described herein may be a combination of hardware and programming. The programming may be processor executable instructions stored on a tangible memory, and the hardware may include a processing device 201 for executing those instructions. Thus system memory 114 of FIG. 1 can be said to store program instructions that when executed by processing device 201 implement the engines described herein. Other engines may also be utilized to include other features and functionality described in other examples herein.

Processing system 200 may include a processor 201, an audio input device 202, an audio output device 203 an interactive questioning engine 204, and a non-verbal sound processing engine 206. Alternatively or additionally, the processing system 200 may include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the techniques described herein.

Audio input device 202 comprises a device suitable for receiving an audio signal and converting it to an electrical signal. For example, audio input device 202 is a microphone. The audio signal may be a non-verbal sound input received from a user. For example, the user may click his teeth, clap his hands, snap his fingers, or generate some other non-verbal sound. Audio input device 202 receives the non-verbal sound and converts it to an electrical signal that can be processed by processing system 200.

Audio output device 203 comprises a device suitable for transmitting an audio signal produced by an electrical signal. For example, audio output device 203 is a speaker. The electrical signal may be produced, for example, by processing system 200, and audio output device 203 transmits an audio representation of the signal. For example, audio output device 203 may transmit music, a spoken voice, or other suitable sounds.

Interactive menu presentation engine 204 presents an interactive menu to a user of processing system 200. The interactive menu may comprise a plurality of interactive menu options. The interactive menu options may presented to the user one at a time, enabling the user to make desired selections. For example, the user may be presented with interactive menu options as yes/no questions, and additional interactive menu options may then be presented based on the user's response.

Non-verbal sound processing engine 206 receives electrical signals from audio input device 202 that correspond to the non-verbal sounds received by audio input device 202. Examples of non-verbal sound inputs include a user clicking his teeth, snapping his fingers, clapping his hands, and the like.

In one non-limiting example, a user may interact with processing system 200 in the following way. The user may generate a non-verbal sound as an initiation command to initiate the interactive menu. For example, the user may click his teeth five times to initiate the interactive menu. Once initiated, and in an example in which processing device 200 is playing music, interactive menu presentation engine 204 may present (via audio output device 203) an interactive menu to the user with a first interactive menu option of “Mute music? Click once for no or twice for yes.” If the user wishes to mute the music, the user may click his teeth twice for yes. Audio input device 202 receives the two clicks and generates a corresponding electrical signal which is interpreted by non-verbal sound processing engine 206 to mute the music. Interactive menu presentation engine 204 may then prompt the user with another interactive menu option. In examples, the user may exit the interactive menu, such as by failing to answer a question or by generating an interactive menu termination command, such as four clicks of the user's teeth.

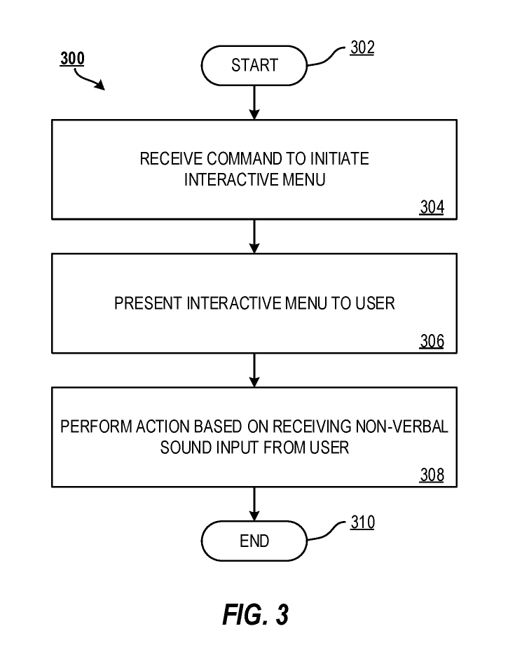

FIG. 3 illustrates a flow diagram of a method 300 for interacting with a processing system using an interactive menu and non-verbal sound inputs according to examples of the present disclosure. The method 300 starts at block 302 and continues to block 304.

At block 304, the method 300 comprises receiving a command to initiate the interactive menu. The command to initiate the interactive menu may be a pre-defined or user-defined sequence of non-verbal sounds inputs received from the user. For example, the command to initiate the interactive menu may be five clicks of the teeth of the user. Similarly, the command to initiate the interactive menu may be three finger snaps of the user. Other types of non-verbal sound inputs and/or other numbers of the inputs may be utilized for the command to initiate the interactive menu.

At block 306, the method 300 comprises presenting the interactive menu to a user of the processing system. In examples, the interactive menu comprises a plurality of interactive menu portions, which may be presented to the user audibly or visually. In examples, interactive menu options are presented audibly to the user such that the user can hear interactive menu options (e.g., “Would you like to send a text message?” or “Click twice to pause the music.”) from a speaker of the user's processing system. In other examples, the interactive menu options are presented visually to the user such that the user can see interactive menu options on a display of the user's processing system.

At block 308, the method 300 comprises performing an action on the processing system based on receiving a non-verbal sound input from the user. The non-verbal sound input may be received from the user responsive to an interactive menu option presented to the user. For example, if the interactive menu asks the user “Would you like to send a text message?” the user's processing system may open a text messaging application on the user's processing system. Examples of actions to be performed by the processing system include at least placing a phone call, sending a text message, initiating an audio recording, opening an application, closing an application, playing/pausing/muting audio or video, and the like, as well as combinations thereof. The actions may be pre-defined and/or user-defined.

The interactive menu may present additional interactive menu options to the user depending upon the user's prior response. That is, certain interactive menu options may prompt follow-up interactive menu options (e.g. “Would you like to send a text message?” followed by “Okay, would you like to send the text message to an existing contact?”). The method 300 continues to block 310 and ends. The interactive menu options may be yes/no questions, the interactive menu options may provide numbered responses (e.g., “Click one time to place a call, click two times to send a text, click three times to start a recording.”), and/or the interactive menu options may provide other types of questions/options suitable for answering with non-verbal sound inputs. In the case of yes/no questions, a two-click of the teeth non-verbal sound input may indicate a yes response while a one-click of the teeth non-verbal sound input may indicate a no response.

Additional processes also may be included, and it should be understood that the processes depicted in FIG. 3 represent illustrations, and that other processes may be added or existing processes may be removed, modified, or rearranged without departing from the scope and spirit of the present disclosure.

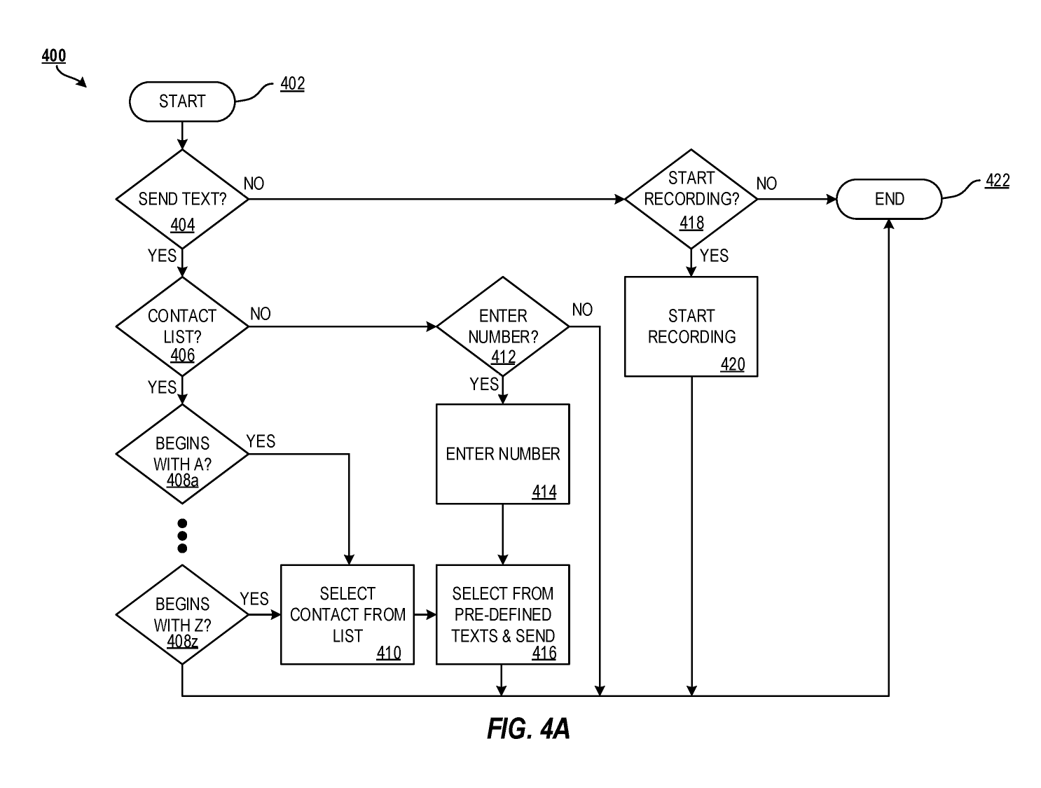

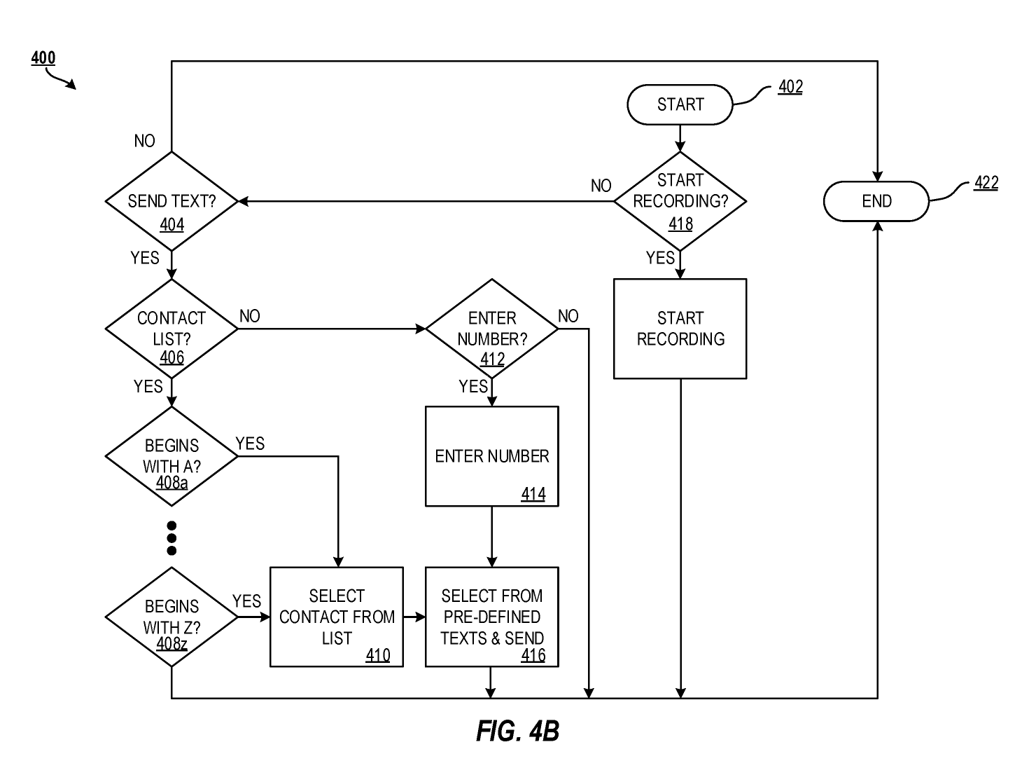

FIGS. 4A and 4B illustrate a flow diagram of a method 400 for navigating an interactive menu according to examples of the present disclosure. The examples of FIGS. 4A and 4B are merely two possible examples of navigating an interactive menu, and it should be appreciated that other suitable methods of navigating interactive menus and interactive menu options are possible, as well as combinations thereof. In the present example, the decision blocks 404, 406, 408, 412 of the interactive menu represent interactive menu options (e.g., questions).

Regarding FIG. 4A, the method 400 begins at block 402 and continues to decision block 404. At decision block 404, the method 400 asks the user whether the user wants to send a text. If not, the method 400 continues to decision block 418. However, if so, at decision block 406, the method 400 asks the user whether the user wishes to select a contact from a contact list. If not, the method 400 continues to decision block 412. However, if so, at decision blocks 408a-408z, the method 400 asks the user to select a letter that the desired contact name begins with, starting with the letter “a” and continuing to the letter “z” until the desired letter is selected. This technique may be iterative until the desired contact is selected from the contact list at block 410. At block 416, the user may then be presented with a list of pre-defined texts to send, and the desired text is sent. The method 400 then continues to block 422 and ends.

If the user answers no to selecting a contact from the contact list at decision block 406, the method 400 continues to decision block 412 and the user is asked whether he wishes to enter a number. If not, the method 400 continues to block 422 and ends. However, if so, at block 414, the user may be prompted to enter the desired number to which the text is to be sent. At block 416, the user may then be presented with a list of pre-defined texts to send, and the desired text is sent. The method 400 then continues to block 422 and ends.

If the user answers no to whether to send a text at decision block 404, the method 400 continues to decision block 418, and the user is asked whether to start a recording (e.g., an audio recording, a video recording, etc.). If so, the method 400 starts a recording at block 420. The method 400 then continues to block 422 and ends. If, however, the user answers no to starting the recording at decision block 418, the method 400 continues to block 422 and ends without starting the recording at block 420.

The example of FIG. 4B is similar to FIG. 4A, except that in the example of FIG. 4B, the method 400 starts at block 402 and continues to decision block 418. This may occur, for example, if the processing system detects that the user is in a meeting such as by observing a meeting event in the user's calendar on the processing system. In this case, the method 400 starts at decision block 418 to ask the user whether to start a recording before other interactive menu options to optimize the user's experience. In another example, if the processing device is playing music or a video, the user may first be presented with an interactive menu option to pause/mute/stop the playback.

Additional processes also may be included, and it should be understood that the processes depicted in FIG. 4 represent illustrations, and that other processes may be added or existing processes may be removed, modified, or rearranged without departing from the scope and spirit of the present disclosure.

The present techniques may be implemented as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some examples, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to aspects of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for interacting with a processing system using an interactive menu and a non-verbal sound input, the method comprising:
receiving a command to initiate the interactive menu;
presenting the interactive menu to a user of the processing system, the interactive menu comprising a plurality of interactive menu options; and
performing an action on the processing system based on receiving a non-verbal sound input from the user responsive to at least one of the plurality of interactive menu options presented to the user.

2. The computer-implemented method of claim 1, wherein the non-verbal sound input is a click of the teeth of the user.

3. The computer-implemented method of claim 2, wherein the command to initiate the interactive menu is five clicks of the teeth of the user, and wherein receiving the non-verbal sound input comprises receiving one of a one-click of teeth response and a two-click of teeth response.

4. The computer-implemented method of claim 3, wherein the interactive menu presents at least a plurality of yes/no questions to the user.

5. The computer-implemented method of claim 4, wherein the one-click of teeth response indicates a no response to one of the plurality of yes/no questions, and wherein the two-click of teeth response indicates a yes response to one of the plurality of yes/no questions.

6. The computer-implemented method of claim 1, wherein the non-verbal sound input is a snapping of fingers of the user.

7. The computer-implemented method of claim 1, wherein the action is at least one of placing a phone call, sending a text message, initiating an audio recording, and opening an application.

8. A system for interacting with a processing system using an interactive menu and a non-verbal sound input, the system comprising:
a processor in communication with one or more types of memory, the processor configured to:
receive a command to initiate the interactive menu,
present the interactive menu to a user of the processing system, the interactive menu comprising a plurality of interactive menu options, and
perform an action on the processing system based on receiving a non-verbal sound input from the user responsive to at least one of the plurality of interactive menu options presented to the user.

9. The system of claim 1, wherein the non-verbal sound input is a click of the teeth of the user.

10. The system of claim 9, wherein the command to initiate the interactive menu is five clicks of the teeth of the user, and wherein receiving the non-verbal sound input comprises receiving one of a one-click of teeth response and a two-click of teeth response.

11. The system of claim 10, wherein the interactive menu presents at least a plurality of yes/no questions to the user.

12. The system of claim 11, wherein the one-click of teeth response indicates a no response to one of the plurality of yes/no questions, and wherein the two-click of teeth response indicates a yes response to one of the plurality of yes/no questions.

13. The system of claim 8, wherein the non-verbal sound input is a snapping of fingers of the user.

14. The system of claim 8, wherein the action is at least one of placing a phone call, sending a text message, initiating an audio recording, and opening an application.

15. A computer program product for interacting with a processing system using an interactive menu and a non-verbal sound input, the computer program product comprising:
a non-transitory storage medium readable by a processing circuit and storing instructions for execution by the processing circuit for performing a method comprising:
receiving a command to initiate the interactive menu,
presenting the interactive menu to a user of the processing system, the interactive menu comprising a plurality of interactive menu options, and
performing an action on the processing system based on receiving a non-verbal sound input from the user responsive to at least one of the plurality of interactive menu options presented to the user.

16. The computer program product of claim 15, wherein the non-verbal sound input is a click of the teeth of the user.

17. The computer program product of claim 16, wherein the command to initiate the interactive menu is five clicks of the teeth of the user, and wherein receiving the non-verbal sound input comprises receiving one of a one-click of teeth response and a two-click of teeth response.

18. The computer program product of claim 17, wherein the interactive menu presents at least a plurality of yes/no questions to the user.

19. The computer program product of claim 18, wherein the one-click of teeth response indicates a no response to one of the plurality of yes/no questions, and wherein the two-click of teeth response indicates a yes response to one of the plurality of yes/no questions.

20. The computer program product of claim 15, wherein the non-verbal sound input is a snapping of fingers of the user.
